(19) United States
(12) Patent Application Publication
(10) Pub. No.: US 2005/0117627 A1
(43) Pub. Date: Jun. 2, 2005

(54) Method for the determination of a maximum or a minimum

(76) Inventor: Gunnar Nitsche, Dresden (DE)

Correspondence Address: BAKER & BOTTS, 30 ROCKEFELLER PLAZA, NEW YORK, NY, 10112, US

(21) Appl. No.: 10/499,857

(22) PCT Filed: Dec. 20, 2002
(86) PCT No.: PCT/DE02/04685

(30) Foreign Application Priority Data
Dec. 21, 2001 (DE) 101 63 700.4

(51) Int. Cl. H04B 1/69

(52) U.S. Cl. 375/130

(57) ABSTRACT

The invention, which relates to a method for ascertaining a maximum or a minimum from a set of comparative values in a communication receiver, is based on the object of specifying a method for ascertaining the maximum or minimum in which, following a comparison operation, the result comprises the maximum or minimum itself and/or the associated index. The invention achieves the object in that following ascertainment of a maximum or minimum the index is used to output the symbol which gives rise to the maximum or minimum from the character set.

The invention relates to a method for ascertaining a maximum or a minimum from a set of comparative values in a communication receiver, in the field of spread spectrum technology, in which received symbols coded using spread spectrum technology are decoded from a received signal and are compared with the character set in the receiver and comparative values are produced as the result of each comparison, each comparative value being assigned an index by producing, for each comparative value, a comparative word which comprises the comparative value and an associated index and subsequently ascertaining the maximum or minimum from the set of comparative words.

Extreme values for numbers, i.e. a maximum or minimum in a set of numerical values, can basically be ascertained at two different levels.

First, they may be ascertained using hardware, with a circuit arrangement designed specifically for this purpose, as illustrated in JP 4123128 AA.

This circuit arrangement simultaneously ascertains the maximum and the minimum in a set of comparative values comprising eight elements. In this arrangement, two comparative values are supplied to each of the changeover switches arranged in parallel with one another at a first level. The result of the comparison operation is that the respective larger of the comparative values is present at the maximum output of the changeover switches and the respective smaller of the comparative values is present at the minimum output. In line with the connections shown, these first-level output variables are input variables for the changeover switches shown at the second level. In this respect, this arrangement is a cascade comprising a plurality of changeover switches.

At the second level too, each changeover switch compares the two input values applied and forwards the results to a third stage as appropriate, with just the minimum or the maximum now being forwarded to the inputs of the subsequent two third-level changeover switches, depending on the changeover switch.

First the maximum value and secondly the minimum value can be tapped off at the outputs of the third stage.

The second way of ascertaining the maximum or the minimum is implementation using software. In this case, comparison and/or sorting algorithms are used which are matched to the respective hardware.

One method in this group is implemented in the manner below, for example. The first two comparative values from the set of comparative values are entered into two input registers in a processing unit. The processing unit compares the two values. When a maximum is ascertained, the larger value is then located in an output register. The two comparative values are then entered in order of magnitude into an order table.

In a subsequent step, the value from the output register described above is entered into the first input register in the processing unit. The third value awaiting comparison is then written to the second input register. In the subsequent comparison between the two values by the processing unit, the ratio of the third comparative value to the maximum value ascertained hitherto is established.

If the third comparative value has been ascertained as the new maximum, the comparative values already entered into the order table are shifted one position backward and the third comparative value is entered into the first table position.

If the third comparative value is smaller than the maximum ascertained hitherto, then a further comparison step needs to be used to examine the ratio of the third comparative value to the second value entered in the order table.

If the result of the comparison establishes that the third comparative value is larger, then the second value entered in the table, and possibly succeeding values, must be shifted backward and the third comparative value must be entered at the table position which is now free.

If the comparison yields the result that the third comparative value is smaller, then the value is entered at the third table position if no value has been entered at this position yet. If there is an entry at this table position, then the value which is to be entered needs to be compared again with the value which has been entered, and an action resulting from the result of the comparison is necessary.

Once this comparison is complete, the current maximum is loaded into the first input register and the fourth comparative value is loaded into the second input register, and the comparison and sorting operation starts again as described above.

The method is more complex in comparison with formation of a pure maximum value or minimum value, since besides the maximum or minimum all other comparative values also need to remain within the order table in a continual access operation.

This method may be referred to as a serial method in which the comparison and sorting complexity increases to an ever greater extent as the number of comparative values rises. The comparison in such a method is often implemented using “If-Then-Else” steps. This requisite order of steps makes the information processing on contemporary signal processes extraordinarily inefficient.

Another method implemented using software is known from DE 198 35 216 A 1, for example, as a method for a processor arrangement with parallel processing units.

In this method, the input registers in all of the processing units arranged in parallel have a first pair of comparative values written to them. In the subsequent comparison operation in the processing units, the respective larger of the two comparative values during determination of a maximum, for example, is written to an output register.

The comparison results from the first comparison are combined into pairs of comparative values again and are entered into the input registers in the processing units, the number of processing units necessary for this second comparison step having been halved.

In a subsequent operation, the maximum for the two comparative values is again determined and entered into the respective output register.

In this case, the number of comparative values is halved for each comparison operation, that is to say that the comparison operation needs to be constantly repeated, as described above, until the definitive maximum has been ascertained. Thus, in the case of an arrangement with eight parallel processing units and sixteen comparative values, for example, four successive comparison operations are needed in order to ascertain the result.

In the case of receivers for transmission methods which are based on spread spectrum technology (e.g. wireless LAN, CDMA, UMTS/3GPP), demodulation generally first involves correlation of the received signal with known sequences and then determination of the maximum of the correlation. In this context, what is of interest is not so much the value of the maximum, but rather the position or the index, because this can be used to determine the most suitable sequence and hence the transmitted information.

All of the methods illustrated involve the output of a maximum or minimum as the result. The index for the maximum or minimum is not available when the comparison method is complete, however.

U.S. Pat. No. 5,752,072 publishes the method for a sorting scheme which requires no comparison or step instructions during program execution and is particularly suitable for computers having a plurality of parallel functional units.

Two numbers or two binary character strings are sorted using arithmetic instructions instead of comparison and/or step instructions. This results in an improvement in the performance of a superscalar processor processing VLIWs.

In addition, when a reduced instruction set in an RISC processor is used, the sorting scheme supports better utilization of floating point arithmetic. The sorting scheme permits floating point representation of data and floating point instructions for sorting binary character strings.

In line with claim 1, the intermediate results e and f are formed in a first step in order to determine a maximum/minimum for two numbers a and b.

The intermediate results e and f are subsequently supplied to an addition and a subtraction operation which involves the results respectively being halved. The result of the addition operation thus indicates the maximum value of the two numbers a and b which are to be compared, and the result of the subtraction operation delivers the minimum value from the comparison.

If it is desirable to process the index for the binary character strings in the sorting method at the same time, then the index can be packed into the floating point word which is to be processed. The scheme used to do so is shown in FIG. 4.

The range of the “i1 bits” is used to map the index information. The more significant range of the “51-i1 bits” is used to store the binary character string to be sorted. The last bit is set to zero, as explained in the descriptive part further above.

Since the index information is mapped in the less significant part of the floating point word, the actual sorting process is not affected thereby. On the other hand, however, the case of equality of the character strings to be sorted is ruled out, since these differ at least by virtue of the added index information. It is thus also possible to ascertain the index for the maximum/minimum after the sorting operation is complete.

If the binary character strings match, the result of the sorting operation is determined by the index values. The floating point word having the lower index is assigned to “c” and represents the minimum, while the floating point word having the higher index is assigned to “d” and hence to the maximum. Such an order principle is desirable for the case of equality of the character strings.

Although this method ascertains the maximum or minimum taking into account the associated index for the comparative value, it still does not permit any inference regarding a received symbol.

The invention is thus based on the object of specifying a method for ascertaining the maximum or minimum from a set of comparative values in a communication receiver in which after the comparison operation has been performed the result comprises the maximum or minimum itself and/or the associated index, and hence a received symbol is ascertained.

The invention achieves the object by virtue of a first step involving each comparative value being assigned an index by producing, for each comparative value, a comparative word x₍ₖ₎ which comprises the comparative value and an associated index and ascertaining the maximum or minimum from the set of comparative words x₍ₖ₎ and then outputting at least the index associated with the maximum or minimum.

If only the comparative values are supplied to a comparison stage or comparison operation, as occurs in the prior art, then although the result contains the maximum or minimum from the comparison it does not contain any indication of the original position or the index of the comparative value. In order to be able to indicate this index, it needs to be taken along by the various comparison stages or comparison operations without influencing the actual comparison. When the maximum or minimum has been determined, the index can be separated from the comparative value again.

In order to couple the index to the comparative value, the invention involves the formation of a comparative word comprising two parts. One part of this word contains the comparative value itself and another part contains the associated index.

In one beneficial form of the method, the comparative word x₍ₖ₎ is formed in binary representation according to the rule x₍ₖ₎=2^{m}*C₍ₖ₎+k, where c₍ₖ₎ are comparative values, k is the index for the comparative value, n is the number of comparative values, m is the number of places for the shift, and the relationship 2^{m}≧n holds true.

One specific form of representation of the comparative word is the binary form, which is suitable for describing the data processing at the processor level. The comparative word is made up of two components. The more significant part of the comparative word contains the comparative value, and the less significant part contains the associated index. In this case, the number of bit places which is required for each part can be matched to the set of comparative values, to the accuracy of the comparison value and to the processing width of the processor system. The comparative word x₍ₖ₎ is formed in line with the equation by shifting the comparative word a stipulated number of bit places m to the left in a first step. The first summand in the equation is responsible for this operation. In a second step, the index for the comparative value is then added, likewise in a binary form.

In one beneficial embodiment of the method, as the result of the comparison operation with all of the comparative words formed, the index for the maximum or minimum is contained in the lower m bits of the comparative word x₍ₖ₎ and is read out.

The index for a comparative value is contained in the lower m bits after the comparative word x₍ₖ₎ has been formed. This position of the index is not adversely affected by a comparison method, which means that after the maximum or minimum has been determined the lower m bits can be separated from the comparative word x₍ₖ₎ and can be output as the result.

In another beneficial form of the method, the maximum or minimum is ascertained from a sorted sequence of all the indicated comparative values.

A software-based sorting method described in the prior art can be used to enter the indicated comparative values into an order table in increasing or decreasing order. This table outputs the first or last comparative word, that is to say the indicated maximum or minimum.

In another beneficial embodiment of the method, the sorted sequence is output.

Besides the output of the indicated maximum or minimum, it is also possible to output a particular number of comparative words from the order table. In this case, it is also possible to output just the comparative value or just the index instead of the comparative word.

The invention will be explained in more detail below with reference to an exemplary embodiment. The associated drawing shows the formation of the comparative word in individual stages.

In a previous process, a received symbol was compared in a receiver stage, operating using spread spectrum technology (e.g. A RAKE receiver), with all of the possible symbols from a character set. This comparison produced “correlation or comparison values” as output values from the RAKE receiver. Following this check for a match, the maximum value in the correlation needed to be determined, since this value represents the greatest match with the received symbol and permits the received symbol itself to be inferred.

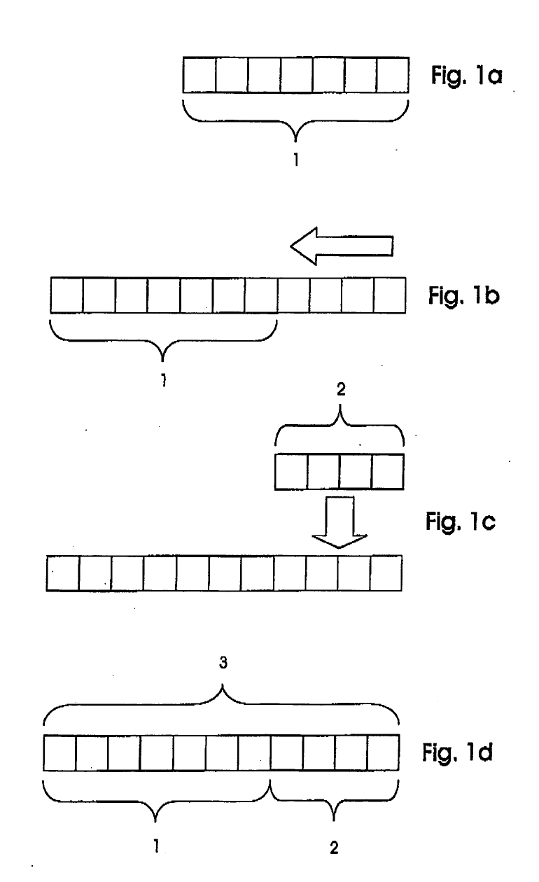

To this end, the comparative word 3 is formed from a comparative value 1 and the associated index 2. In a first step, the binary comparative value c₍ₖ₎ 1 (FIG. 1a) is shifted m bits to the left, where m is defined by the number of bit places which is required for the index 2 and will be four in the example. When the shift operation has taken place, the temporary comparative word 3 shown in figure 1b is produced.

In the next step, the associated (in the example, four-place) binary index 2 is added to the previous comparative word 3 in line with the structural equation in subclaim three. For the structural example, the index has the value 3 (0011 in binary). Since the four least significant bit places are all zero, the addition may also be regarded as simple insertion of the index 2 into these bit places.

This produces the comparative word 3. The subsequent comparison is not affected by the addition of the index 2 to the least significant bit places, since the comparative value 1 contained in the more significant bit places determines the result of the comparison operation on account of the greater significance of these bit places.

The comparison operation itself can be performed, by way of example, using a processor arrangement which contains eight processing units in parallel. Each processing unit has two input registers to which a total of sixteen comparative words 3 are written. In a subsequent comparison step, each processing unit determines the maximum for the applied pair of comparative words and enters the larger comparative word 3 into an output register. Following this comparison step, the number of comparative words 3 which are suitable for the maximum has been halved. In a subsequent step, pairs of comparative words are formed from the eight intermediate maxima again and are written to the input registers in the processing units again. For the comparison operation which follows, only four processing units are now required. The result yields the larger comparative word 3 in the pair, which is in turn written to the output register. These comparison operations are performed until the final maximum has been established.

When the comparison operations are complete, the maximum for the comparative values 1 is defined in a representation of a comparative word 3. The four least significant bit places are read from the comparative word 3 and are transferred as index 2 for the subsequent sequence or information determination in the receiver.

List of reference numerals

1 Comparative value c₍ₖ₎
2 Index for the comparative value c₍ₖ₎
3 Comparative word x₍ₖ₎

1. A method for ascertaining a maximum or a minimum from a set of comparative values in a communication receiver, in the field of spread spectrum technology, in which received symbols coded using spread spectrum technology are decoded from a received signal and are compared with the character set in the receiver and comparative values are produced as the result of each comparison, each comparative value (1) being assigned an index (2) by producing, for each comparative value, a comparative word x₍ₖ₎ (3) which comprises the comparative value (1) and an associated index (2) and subsequently ascertaining the maximum or minimum from the set of comparative words x₍ₖ₎ (3), characterized in that following ascertainment of a maximum or minimum the index (2) is used to output the symbol which gives rise to the maximum or minimum from the character set.

2. The method as claimed in claim 1, characterized in that the comparative word x₍ₖ₎ (3) is formed in binary representation according to the rule x₍ₖ₎=2^{m}*C₍ₖ₎+k, where c₍ₖ₎ are comparative values (1), k is the index (2) for the comparative value (1), n is the number of comparative values (1), m is the number of places for the shift, and the relationship 2^{m}≧n holds true.

3. The method as claimed in claim 1 or 2, characterized in that, as the result of the comparison operation with all of the comparative words (3) formed, the index (2) for the maximum or minimum is contained in the lower m bits of the comparative word x₍ₖ₎ (3) and is read out.

4. The method as claimed in claim 1 or 2, characterized in that the maximum or minimum is ascertained from a sorted sequence comprising all of the indicated comparative values.

5. The method as claimed in claim 4, characterized in that the sorted sequence is output.
